(19) United States
(12) Patent Application Publication
(10) Pub. No.: US 2025/0392092 A1
(43) Pub. Date: Dec. 25, 2025

(54) METHOD AND TOOL FOR PROCESSING ELECTRICAL CONTACTS FROM A CARRIER UNIT

(71) Applicant: HARTING Electric Stiftung & Co. KG, Espelkamp (DE)

(72) Inventors: Daniel WESSELER, Espelkamp (DE); Joachim KRAEMER, Espelkamp (DE)

(21) Appl. No.: 18/880,515

(22) PCT Filed: Jul. 6, 2023
(86) PCT No.: PCT/DE2023/100510

§ 371 Date: Dec. 31, 2024

(30) Foreign Application Priority Data
Jul. 29, 2022 (DE) 10 2022 119 053.6

(51) Int. Cl. H01R 43/055

(52) U.S. Cl. CPC H01R 43/055

(57) ABSTRACT

Disclosed are a method for irreversibly connecting an electrical contact to an electrical conductor by way of a crimping apparatus operated under the effect of an external force, more particularly a crimping machine operated under the effect of an external force. The contact is produced by a machining process, has at least one electric connecting region and at least one crimping region and is integrated into a belt-like carrier unit

### BACKGROUND OF THE INVENTION

The invention relates to a method for processing electrical contacts by means of a crimping device. Furthermore, the invention proceeds from a tool for carrying out such a method. Furthermore, the invention proceeds from a crimping device for receiving a tool according to the method for carrying out the method.

Crimping devices of this type and associated tools are required to irreversibly connect electrical contacts to electrical conductors. Crimping devices, such as crimping machines and/or automatic crimping machines, are used to carry out in a (semi-)automatic manner, operated under the effect of an external force, crimping of electrical contacts onto an electrical conductor, conventionally a cable (which is stripped in part).

Many clever and helpful crimping devices are known in the prior art. However, most (semi-)automatic crimping devices are configured to apply stamped contacts. These are stamped and formed by a coil, wherein a small strip of the coil remains and is used to interconnect contacts formed in this manner as a carrier strip. These carrier strips, together with the contacts located thereon, are wound onto a roll for easy transportation and processing.

However, there is no such advantageous means for contacts which have been produced by a machining process, for example by turning. For contacts of this type, sorting devices conventionally have to be integrated in a crimping device or arranged on a crimping device.

DE 6803967 U discloses a pneumatically operated crimping device for plug-in contact elements, comprising a sorting container which allows the plug-in contact elements which are in the suitable position with the opening which is intended to receive the line wires to enter in advance into the supply connectors of the supply means operated with compressed air, and comprising a crimping tool part which is controlled by a foot valve and is operated with compressed air, wherein the foot valve connected to a compressed air supply line is connected to the compressed air cylinder via an additional compressed air line.

U.S. Pat. No. 3,460,230 A discloses a device for fixing an electrical contact to an electrical conductor, comprising a hopper containing a plurality of electrical contacts and adapted to dispense the contacts from a predetermined location on the periphery of the hopper and at a predetermined rate, and a track assembly cooperating with the hopper and positioned adjacent to the predetermined location for receiving the contacts in an in-line fashion and in a predetermined orientation as they are dispensed from the hopper so that contacts can subsequently be connected to a conductor in the device.

The disadvantage of the prior art is the space-wasting sorting devices which cannot easily be arranged on existing crimping devices.

### SUMMARY OF THE INVENTION

The object of the invention consists in disclosing a method which makes it possible to process contacts produced by machining in (semi-)automatic crimping devices without a sorting device.

Another object of the invention consists in providing a tool for a crimping device which makes it possible to connect contacts and conductors in a manner according to the method.

Another object consists in providing a crimping device which receives a tool according to the invention and carries out the method according to the invention.

Further embodiments of the invention are indicated in the dependent claims and the following description.

In order to achieve the object, a method is proposed for irreversibly connecting an electrical contact to an electrical conductor by means of a crimping device which is operated under the effect of an external force, in particular a crimping machine which is operated under the effect of an external force. The contact is produced by means of a machining process, comprises at least one electrical connection region and at least one crimping region and is integrated in a belt-like carrier unit. The carrier unit comprises a plurality of consecutive contact supports which each receive a contact in the same orientation and in principle mutually parallel to one another.

The crimping device actuates at least one tool by means of at least one actuator which is operated under the effect of an external force in order to carry out crimping of the crimping region onto the electrical conductor.

The tool of the crimping device detaches the electrical contact from the carrier unit and carries out the crimping of the crimping region of the contact on the electrical conductor.

When producing contacts by means of a machining process, machine turning is usually used. As a result of the solid material located in the connection region, the contacts produced by turning usually provide improved current carrying capacity so that higher currents can be transmitted.

The crimping region of the contact means the region which receives an electrical conductor, usually a wire of a cable, and under the effect of a force, is crimped in such a way that an electrically conductive connection is produced between the contact and the electrical conductor.

Analogously, the connection region of the contact is the region which is designed for connection to a corresponding contact. Thus, in the case of a turned pin contact, the connection region is a pin region which is formed (from solid material), which is brought into electrically conductive connection for example with a socket contact.

A carrier unit is to be understood to mean a contact-carrying device which allows the crimping device, after a process of crimping a contact, to move a next contact, wherein no separate sorting device has to be used. The carrier unit substantially replaces a carrier strip, as can be found in the case of stamped contacts. The turned contacts arranged in the carrier unit are thus presorted and connected to the carrier unit. It is thus possible to simplify the use for various embodiments of crimping devices. The carrier unit can be produced from a textile fabric. Advantageously, the carrier unit is produced from a flexible and/or resilient plastics material. The contact supports of the carrier unit are cleverly formed as hollow partial cylinders. Particularly preferably, a carrier unit is used which comprises two part-annular elements per contact support. The part-annular elements ideally receive the contacts at one end of the crimping region, wherein the end provides an opening to a crimping region of the contact and a transition region between the crimping region and the contact region. Connector elements are advantageously provided between the contact supports. The connector elements for example keep the contact supports in shape, as a result of which the contacts remain securely supported. Moreover, by applying force to these connector elements, a contact can be detached from the contact supports.

Actuators which are operated under the effect of an external force generally means actuators which are operated by mechanical energy, electrical energy, pneumatic energy, hydraulic energy, or a combination of the above-mentioned forces, which are not generated by a user assigned to and/or operating the crimping device. In the prior art, in particular pneumatic crimping devices are used, since these can quickly and reliably carry out crimping of contact elements by means of pressure control.

Within the scope of the invention, a tool means both a compression element, for example a die and/or a punch, and a counterpressure element, that is to say an anvil or a mold. By means of the actuator which is operated under the effect of an external force, in this case, the compression element is moved toward the counterpressure element, wherein the contact to be crimped, expediently together with the conductor to be connected, is located with the crimping region between the compression element and the counterpressure element and is crimped thereby in such a way that the conductor and the contact are irreversibly connected in an electrically conductive manner. According to the invention, the tool detaches the contact from the carrier unit before, during and/or after the crimping process.

In one embodiment, the actuator which is operated under the effect of an external force transfers the tool at least into a starting position, into a detaching position and into a crimping position.

A starting position means the position which is occupied when the crimping device is in a stationary, activated state.

A detaching position is to be understood to mean the position in which the tool detaches the contact to be crimped from the carrier unit.

Therefore the crimping position is a position in which the compression element and the counterpressure element of the tool are brought together in such a way that crimping of the contact takes place in the crimping region, that is to say a plastic deformation of the contact, by means of which the irreversible connection between the contact and the conductor is produced.

Another embodiment provides that the actuator comprises at least one eccentric, and transfers the tool in a fundamentally cyclical manner into the various operating positions thereof.

In a clever embodiment, after the crimping process, the crimping device moves the carrier unit in such a way that another contact can be connected to another electrical conductor by means of the crimping device.

This embodiment allows at least a semiautomatic process, which can be fully automated by means of simple adaptations. In this case, a control can be cleverly be implemented in such a way that, when an end of the carrier unit is reached, the semiautomatic and/or automatic process is interrupted.

An expedient embodiment proposes that the crimping device carries out the following steps;
a) moving the contact to the tool,
b) fixing the contact by means of the tool,
c) detaching the contact from the carrier unit,
d) crimping the contact along the crimping region
e) releasing the contact.

According to the invention, the steps are carried out in the above-mentioned order. However, it can also be expedient to switch steps c) and d).

In a clever embodiment, the tool detaches the contact from the carrier unit by means of at least one force which is oriented substantially orthogonally to the carrier unit.

A force which is orthogonal to the carrier unit means very specifically a force which is additionally oriented orthogonally to the longitudinal axis of a contact. Alternatively, a contact can be detached, in the direction of the longitudinal axis thereof, from the carrier unit, but the configuration of the tool and/or of the crimping device which is required for this purpose is complex.

Another object of the invention is achieved by a tool for use in a crimping device which is operated under the effect of an external force, in particular a crimping machine which is operated under the effect of an external force, comprising a compression element, for example a die, and a counterpressure element, for example an anvil, wherein the compression element is formed in at least two parts. According to the invention it is proposed that the compression element is constructed from at least one crimping element and at least one detaching element. Particularly preferably, a tool comprising a crimping element having at least one crimping form and two detaching elements is proposed, wherein the crimping element is arranged between the two detaching elements. In this way, the tool makes it possible to carry out the method steps according to the invention in a particularly advantageous manner.

In one developed embodiment, actuated by means of the crimping device and the actuator thereof which is operated under the effect of an external force, the tool firstly conveys the crimping element to fix the contact.

According to this development, an embodiment provides that, by means of the crimping device and the actuator thereof which is operated under the effect of an external force, after fixing the contact, the tool detaches the fixed contact from the carrier unit by means of the detaching element. The detaching elements are lowered and detach the contact from the carrier unit. Lastly, the crimping element is finally lowered, wherein the contact is crimped in the crimping region thereof and thus connected to a conductor.

Lastly, the application provides a crimping device, in particular a crimping machine which is operated under the effect of an external force, which, at least semiautomatically, brings electrical contacts into irreversible connection with electrical conductors by means of crimping. The crimping means is configured to receive a previously described tool in order to carry out the method described at the outset.

### BRIEF DESCRIPTION OF THE DRAWINGS

An exemplary embodiment of the invention is shown in the drawings and explained in greater detail in the following. In the drawings:

FIG. 1 shows a detail of a crimping device according to the invention with a tool in a starting position;

FIG. 2 shows a detail of a crimping device according to the invention with a tool in a fixing position;

FIG. 3 shows a detail of a crimping device according to the invention with a tool in a detaching position;

### DETAILED DESCRIPTION OF THE INVENTION

The drawings contain schematic illustrations which are simplified in part. In some cases, the same reference signs are used for like but not necessarily identical elements. Different views of the same elements could be scaled differently. Directional information such as “left,” “right,” “top” and “bottom” are to be understood by reference to the respective drawings and can vary with respect to the object shown in the individual illustrations.

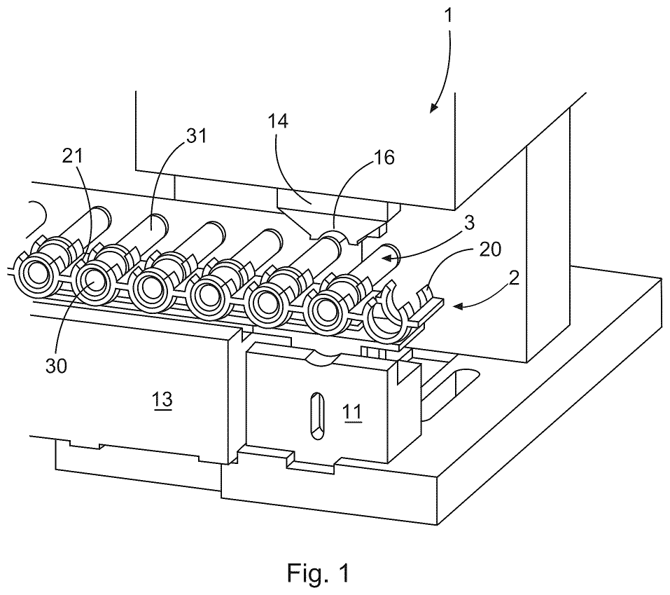

FIG. 1 is a detail view of a tool 1 according to the invention used in a crimping device 10 according to the invention. In this case, the crimping device 10 and the tool 1 located therein are in a starting position. The starting position is ideally occupied when the crimping device 10 is ready for use but has not yet been activated. This means that the crimping device 10 is supplied with energy, but a crimping process has not yet been initiated. The crimping device 10 receives a compression element, consisting of a crimping element 14 and two detaching elements 12 and 12′ flanking the crimping element 14, wherein the detaching elements 12 and 12′ cannot be seen in the illustrated position of the tool 1. In this case the crimping element 14 has a crimping form 16 which has a positive effect on the crimping process. The crimping form 16 can thus be used in such a way that excessive force is not applied to the crimping, which can lead to damage to and/or the destruction of the conductor and/or contact. Another component of the tool 1, the counterpressure element 11, in the form of an anvil, or mold, can be seen. Furthermore, a support 13 for receiving a carrier unit 2 can be seen. The carrier unit 2 comprises contact supports 20 which consist of two partial rings which are connected by connector elements 21, shown as bar elements or connecting pieces. The carrier unit 2 receives like or at least similar contacts 3. The contacts 3 are formed with a crimping region 30 in which a connection region 31 is arranged. In this case, it can clearly be seen that the contact supports 20 receive the contacts 3 on the crimping region 30 thereof, and fix the contacts in the carrier unit.

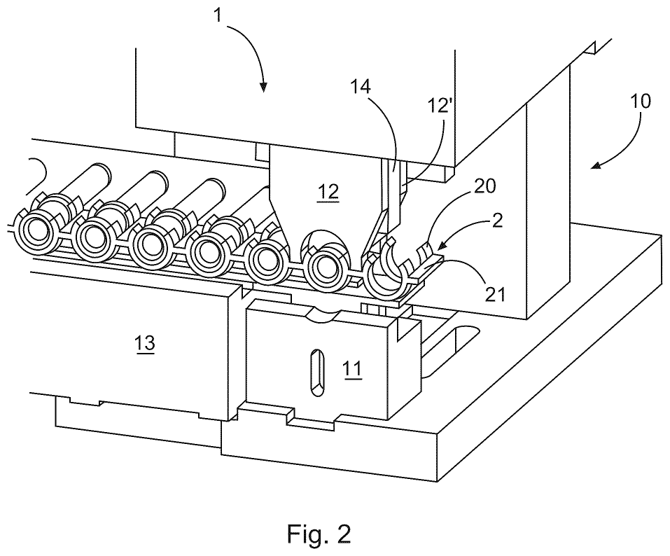

In FIG. 2, the design of the tool 1 is clear. The tool 1 comprises two detaching elements 12 and 12′, between which the crimping element 14 is arranged. The illustrated position of the tool 1 is the fixing position in which the crimping element 14 fixes the contact 3.

The detaching elements 12 and 12′ remain slightly above or on the connector elements 21 to the side of the contact 3 to be crimped. In the case of a semiautomatic operation of the crimping device 10, an electrical conductor can then be inserted in the crimping region 30 of the contact 3.

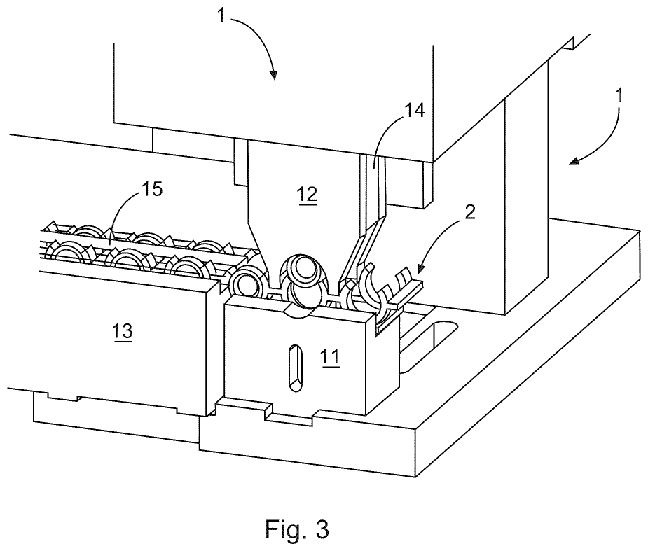

In FIG. 3, a detaching position of the tool 1 is illustrated. In this case, the contact 3 initially remains fixed between the crimping element 14 of the compression element and the counterpressure element 11. The carrier unit 2 is moved by the detaching elements 12 and 12′ in the advancing direction of the detaching elements 12 and 12′ and detached from the fixed contact 3. The final crimping of the contact 3 can optionally already be carried out. Alternatively, a final crimping can be carried out by the crimping element 14 after detaching the contact 3. In one embodiment, the carrier unit 2 can be held in position in the support 13 by a hold-down piece 15.

1. A method for irreversibly connecting an electrical contact to an electrical conductor by a crimping device operated under the effect of an external force, in particular a crimping machine operated under the effect of an external force, wherein the contact comprises at least one electrical connection region and at least one crimping region and is integrated in a belt-like carrier unit which receives a plurality of consecutive contact supports which each receive a contact in the same orientation and in principle mutually parallel to one another,
wherein the crimping device actuates at least one tool by at least one actuator which is operated under the effect of an external force in order to carry out crimping of the crimping region onto the electrical conductor, and
wherein a tool of the crimping device both detaches the electrical contact from the carrier unit and also carries out the crimping of the crimping region of the contact to the electrical conductor.

2. The method as claimed in claim 1, wherein
the actuator which is operated under the effect of an external force transfers the tool at least into a starting position, into a detaching position and into a crimping position.

3. The method as claimed in claim 1, wherein
the actuator comprises at least one eccentric and transfers the tool in a fundamentally cyclical manner into the various operating positions thereof.

4. The method as claimed in claim 1, wherein after the crimping process, the crimping device moves the carrier unit in such a way that another contact can be connected to another electrical conductor by using the crimping device.

5. The method as claimed in claim 1, wherein the crimping device carries out the following steps;
a) moving the contact to the tool,
b) fixing the contact by using the tool,
c) detaching the contact from the carrier unit,
d) crimping the contact along the crimping region
e) releasing the contact.

6. The method as claimed in claim 1, wherein
the tool detaches the contact from the carrier unit by at least one force which is oriented substantially orthogonally to the carrier unit.

7. The method as claimed in claim 1, wherein
the contact is produced by tensile-compressive forming.

8. The method as claimed in claim 1, wherein
the contact is produced by a machining process.

9. The method as claimed in claim 1, wherein
the contact is produced by turning, in particular machine turning.

10. A tool for use in a crimping device which is operated under the effect of an external force, in particular a crimping machine which is operated under the effect of an external force, comprising a compression element and a counterpressure element, wherein
the compression element is formed in at least two parts.

11. The tool as claimed in claim 10, wherein
the compression element comprises a crimping element and a detaching element.

12. The tool as claimed in claim 10, wherein
by the crimping device and the actuator thereof which is operated under the effect of an external force, the tool firstly conveys the crimping element to fix the contact.

13. The tool as claimed in claim 10, wherein
by the crimping device and the actuator thereof which is operated under the effect of an external force, after fixing the contact, the tool detaches the fixed contact from the carrier unit by using the detaching element.

14. A crimping device, in particular a crimping machine which is operated under the effect of an external force, which, at least semi-automatically, brings electrical contacts into irreversible connection with electrical conductors by crimping.
wherein
the crimping device receives a tool which is operated under the effect of an external force, in particular a crimping machine which is operated under the effect of an external force, comprising a compression element and a counterpressure element, wherein the compression element is formed in at least two parts in order to carry out a method as claimed in claim 1.
